(19) United States
(12) Patent Application Publication
(10) Pub. No.: US 2018/0272827 A1
(43) Pub. Date: Sep. 27, 2018

(54) Vehicle Twist Axle Assembly

(71) Applicant: MAGNA INTERNATIONAL INC, Aurora (CA)

(72) Inventor: Kevin Richard Langworthy, Davisburg, MI (US)

(21) Appl. No.: 15/525,114

(22) PCT Filed: Nov. 6, 2015
(86) PCT No.: PCT/US15/59537

§ 371 Date: May 8, 2017

Related U.S. Application Data
(60) Provisional application No. 62/076,949, filed on Nov. 7, 2014.

(51) Int. Cl. B60G 21/05; B21D 7/14

(52) U.S. Cl. CPC B60G 21/052; B21D 7/14; B60G 2200/21; B23K 2201/006; B60G 2206/8103; B60G 2206/8201; B60G 2206/20

(57) ABSTRACT

The twist axle assembly includes a twist beam which is made of a single integral piece and extends along a length between opposite ends. The twist beam has a middle portion which extends in a first direction and a pair of end portions which extend at least partially in a second direction that is generally transverse to the first direction to reduce twisting stresses within the end portions during operation of the twist axle assembly.

### CROSS REFERENCE TO RELATED APPLICATION

This PCT Patent Application claims the benefit of and priority to U.S. Provisional Patent Application Ser. No. 62/076,949 filed Nov. 7, 2014, the entire disclosure of the application being considered part of the disclosure of this application, and hereby incorporated by reference.

### BACKGROUND OF THE INVENTION

### 1. Field of the Invention

The present invention is related, generally, to twist axle assemblies of the type for use in vehicle suspension systems.

### 2. Related Art

A twist beam rear axle suspension assembly, also known as a torsion beam axle, is a type of automobile suspension system including a pair of trailing arms, each of which is coupled with a wheel of a vehicle and with an axle of the vehicle, and a twist beam which extends transversely between the trailing arms. During operation of the vehicle, the twist beam deforms in a twisting movement when one of the wheels moves relative to another, such as during vehicle body roll or when one of the wheels encounters, for example, a pothole or an obstacle in a road. The twisting movement of the twist beam absorbs this movement to make the ride more comfortable for occupants in the vehicle body.

Typically, the opposite ends of the twist beam and the trailing arms are interconnected with one another via welding, and the weld joints are typically located forwardly of the portions of the trailing arms which are connected with the wheels of the vehicle. However, during use, this configuration has the effect of subjecting the weld joints to large moments and thus to large stresses. There remains a need to reduce the stresses applied to the weld joints of such a twist axle assemblies.

### SUMMARY OF THE INVENTION AND ADVANTAGES

One aspect of the present invention provides for a twist axle assembly for a vehicle suspension. The twist axle assembly includes a twist beam which is made of a single integral piece and extends along a length between opposite ends. The twist beam has a middle portion which extends in a first direction and a pair of end portions which extend at least partially in a second direction that is generally transverse to the first direction to reduce twisting stresses within the end portions during operation of the twist axle assembly.

According to another aspect of the present invention, a pair of wheel carriers are welded to the end portions of the twist beam

According to still another aspect of the present invention, a pair of spring seats are welded to the end portions of the twist beam.

According to yet another aspect of the present invention, the end sections are curved from the first direction to the second direction.

According to a further aspect of the present invention, the middle portion has a pocket formed therein to decrease a torsional stiffness of the middle portion.

Another aspect of the present invention provides for a method of making a twist axle assembly. The method includes the step of preparing a single piece twist beam which extends in a first direction between opposite ends. The method continues with the step of bending the twist beam adjacent the ends to present end portions which are disposed on opposite sides of the middle portion and wherein the middle portions extend at least partially in a second direction that is generally transverse to the first direction. The method continues with the step of welding at least one component (for example, a wheel carrier or a spring seat) to at least one of the end portions of the twist beam.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is an exploded view of an exemplary embodiment of a twist axle assembly for a vehicle suspension system;

FIG. 2 is an isometric view of the twist axle assembly of FIG. 1;

FIG. 3 is an isometric view of the twist axle assembly of FIG. 1 taken from a different vantage point than the isometric view of FIG. 2;

FIG. 4 is a top elevation view of the twist axle assembly of FIG. 1;

FIG. 5 is a bottom elevation view of the twist axle assembly of FIG. 1;

FIG. 6 is a front elevation view of the twist axle assembly of FIG. 1; and

FIG. 7 is a back elevation view of the twist axle assembly of FIG. 1.

### DESCRIPTION OF THE ENABLING EMBODIMENT

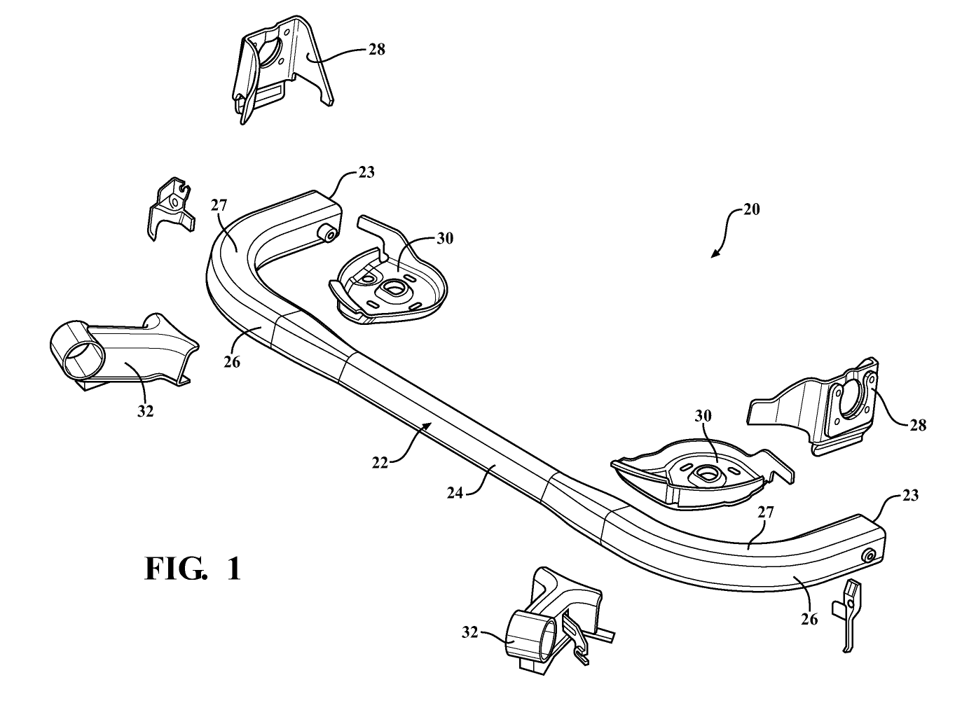

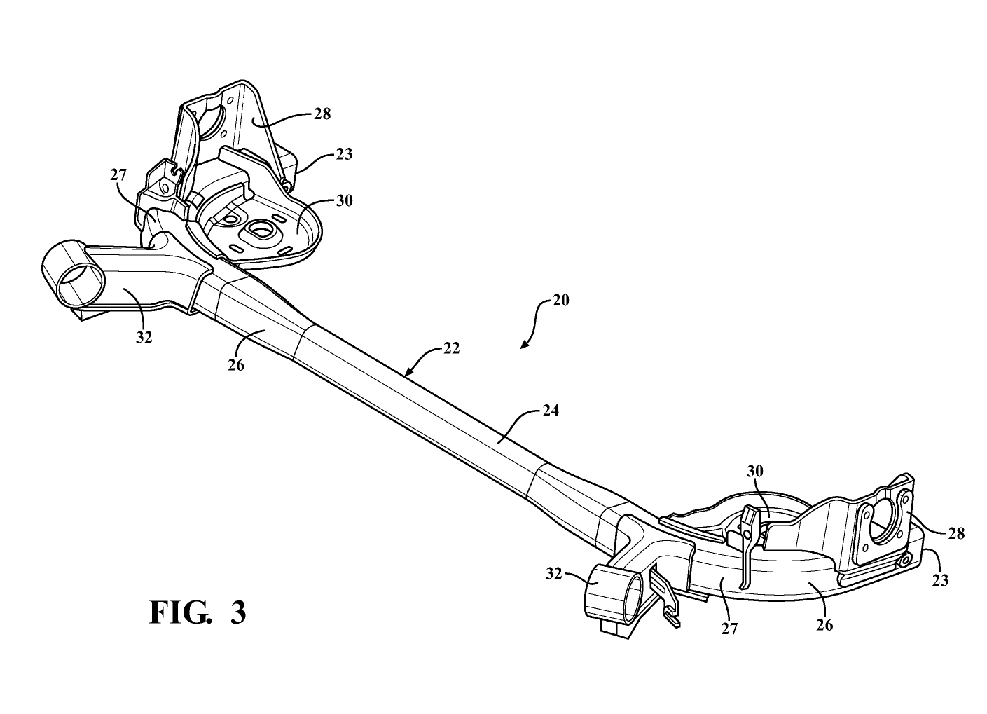

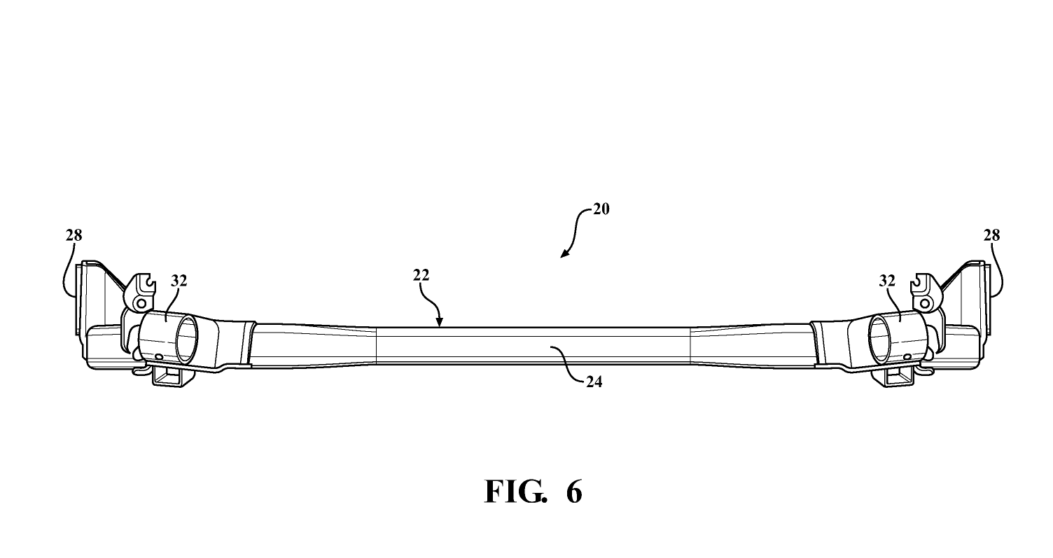

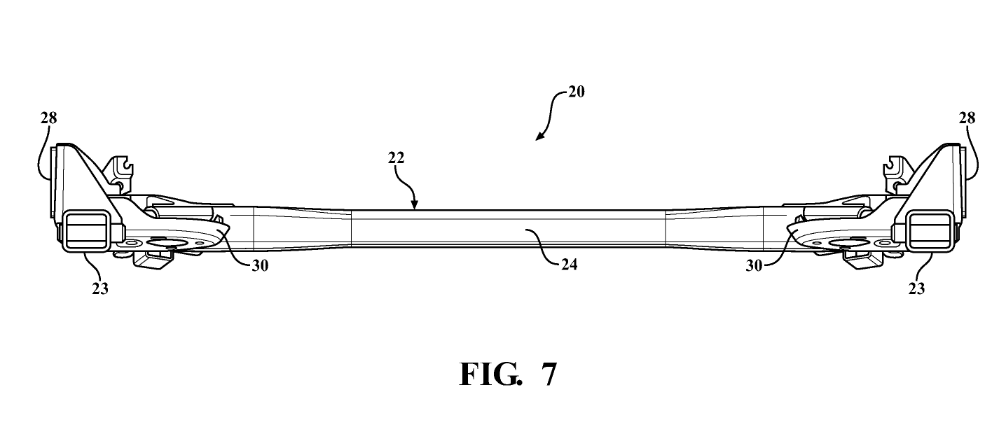

Referring to the Figures, wherein like numerals indicate corresponding parts throughout the several views, an exemplary embodiment of an improved twist axle assembly 20 for use in a vehicle suspension system is generally shown in FIGS. 1-7. The twist axle assembly 20 includes a twist beam 22 (sometimes also known as a cross-member) which is made as a single integral piece and extends between opposite ends 23. The twist beam 22 is preferably made of an elastically deformable metal, such as aluminum, an aluminum alloy, nickel, magnesium, a magnesium alloy, steel or a steel alloy. However, it should be appreciated that any suitable material may be employed.

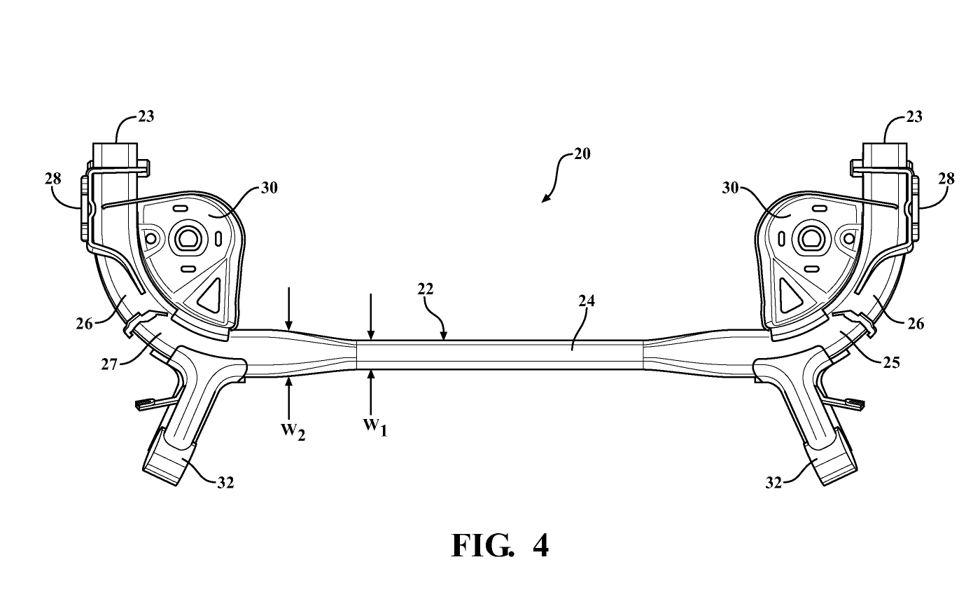

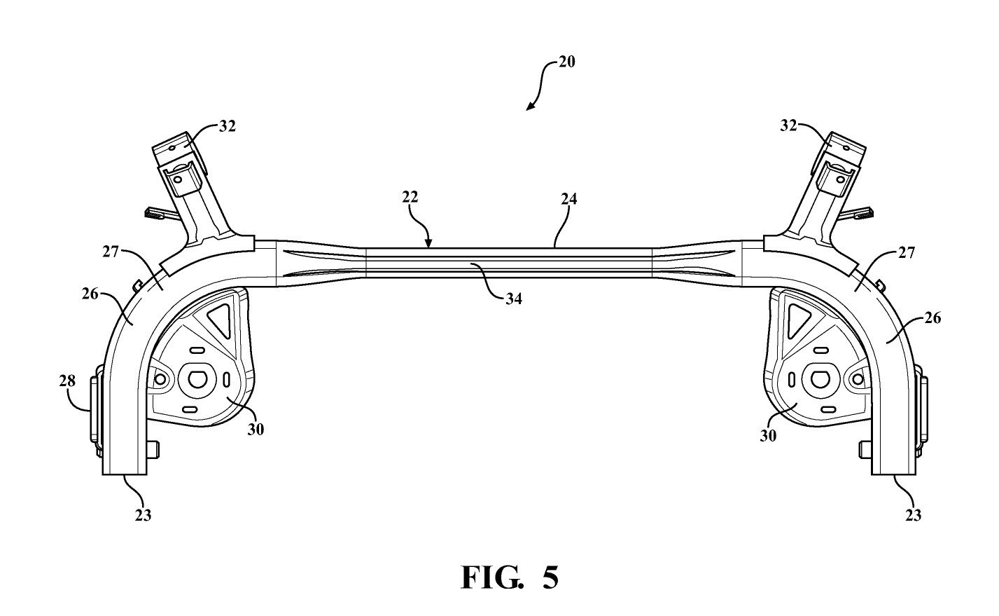

The exemplary embodiment of the twist beam 22 has a middle portion 24 which extends in a first direction (hereinafter referred to as a “lateral direction”) and a pair of end portions 26 which present approximately ninety degrees curves 27 which curve from the lateral direction into a second direction (hereinafter referred to as a “longitudinal direction”) which extends generally transversely to the first direction. The curves 27 of the end portions 26 could have any suitable radiuses that do not cause crimping in the twist beam 22 during the bending process. Preferably, the curves 27 are similarly shaped such that the twist beam 22 is generally symmetrical about a plane that extends through a longitudinal midpoint of the twist beam 22. As such, the twist beam 22 is generally U-shaped when viewed from above or below (see FIGS. 4 and 5). The first and second directions are referred to herein as lateral and longitudinal directions respectively to reflect the orientation of the twist beam 22 once it is installed in a vehicle.

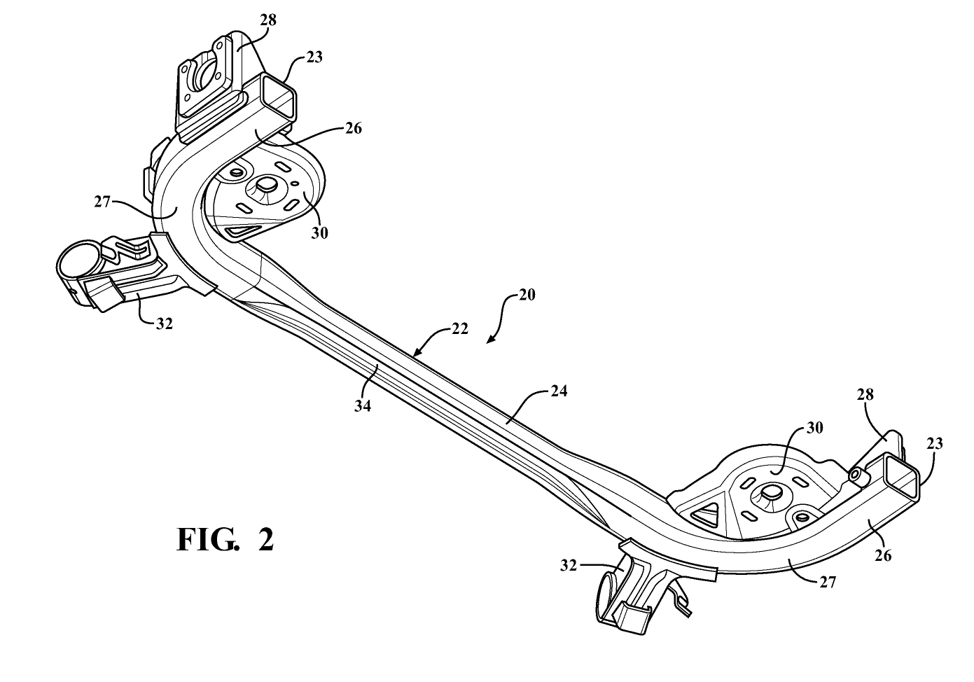

When installed in the vehicle, the twist beam 22 is oriented such that the end portions 26 of the twist beam 22 are curved in a rearward longitudinal direction (towards the back of the vehicle). As shown in FIG. 2, a wheel carrier 28 and a spring seat 30 are attached with each of the end portions 26 via weld joints (such as, for example, MIG welding, GTAW welding or laser welding). The wheel carriers 28 are configured for attachment to a hub (not shown) of a wheel assembly, and the spring seats 30 is configured to engage an end of a compression spring (not shown). During operation of the vehicle, forces are transmitted from the spring seats 30 and the wheel carriers 28, through the weld joints and into the twist beam 22. This causes the middle portion 24 of the twist beam 22 to elastically twist, thereby pivoting the end portions 26 relative to one another and absorbing forces with minimal twisting within the end portions 26. Because the weld joints are with the end portions 26, which extend at least partially in the longitudinal direction, the weld joints are subjected to reduced moments and stresses as compared to the weld joints of other known twist axle assemblies. Since the weld joints are protected from the bending moments, the twist axle assembly 20 exhibits improved durability as compared to other known twist axle assemblies.

The twist axle assembly 20 further includes a pair of body mounts 32 which are also welded to the end portions 26 of the twist beam 22 and extend longitudinally forward therefrom, i.e., in the opposite direction of the curves 27. Each of the body mounts 32 includes a bearing sleeve for receiving a portion of a vehicle unibody (not shown) to interconnect the twist axle assembly 20 with the vehicle unibody.

As shown in FIG. 1, the wheel carriers 28, spring seats 30 and body mounts 32 are all made separately from one another and from the twist beam 22. The wheel carriers 28, spring seats 30 and body mounts 32 all have at least one surface which is shaped similarly to an outer surface of the end portions 26 of the twist beam 22 to facilitate elongated weld seams between these components and the twist beam 22. These surfaces could be shaped to provide for so-called “glove” fitting connections with the twist beam 22 where the components engage both upper and lower surfaces of the twist beam 22.

The exemplary twist beam 20 is of a tubular design and has a closed cross-section along its length between the opposite ends 23. In order to facilitate the twisting of the middle portion 24 to allow the end portions 26 to pivot relative to one another during operation of the suspension system, the middle portion 24 of the exemplary twist beam 22 is deformed, or collapsed, to present a pocket 34. At the pocket 34, the middle portion 24 has a double-walled U-shape when viewed in cross-section. This shape has the effect of reducing the twisting resistance (also known as the torsional stiffness) of the middle portion 24 while allowing for increased twisting resistance in the end portions 26 which lack the pocket 34. The pocket 34 is tapered adjacent the end portions 26 of the twist beam 22 to allow for transitions in the torsional stiffness between the end portions 26 and the middle portion 24. To further reduce the torsional stiffness of the middle portion 24 relative to the end portions 26, as shown in FIG. 4, the middle portion 24 of the twist beam 22 has a first width W₁, and the end portions 26 of the twist beam 22 have a second width W₂ which is greater than the first width W₁.

Another aspect of the present invention provides for a method of making a twist axle assembly 20. The method includes the step of preparing a single piece twist beam 22 which extends in a first direction between opposite ends 23. The method continues with the step of bending the twist beam 22 adjacent the ends 23 to present end portions 26 which extend at least partially in a second direction that is generally perpendicular to the first direction. Preferably, each of the end portions 26 is bent by approximately ninety degrees. The method continues with the step of pressing the middle portion 24 to define a pocket 34 in the middle portion 24. The method proceeds with the step of welding a wheel carrier 28, a spring seat 30 and a body mount 32 to each of the end portions 26. The welding could be, for example, MIG, GMAW or laser welding.

Obviously, many modifications and variations of the present invention are possible in light of the above teachings and may be practiced otherwise than as specifically described while within the scope of the appended claims.

1. A twist axle assembly for a vehicle, comprising:
a twist beam of a single integral piece and extending along a length between opposite ends; and
said twist beam having a middle portion which extends in a first direction and a pair of end portions which extend at least partially in a second direction that is generally traverse to said first direction to reduce twisting stresses within said end portions during operation of said twist axle assembly.

2. The twist axle assembly as set forth in claim 1 further including a pair of wheel carriers which are connected with said end portions of said twist beam.

3. The twist axle assembly as set forth in claim 2 wherein said wheel carriers are welded with said end portions of said twist beam.

4. The twist axle assembly as set forth in claim 1 further including a pair of spring seats which are connected with said end portions of said twist beam.

5. The twist axle assembly as set forth in claim 4 wherein said spring seats are welded with said end portions of said twist beam.

6. The twist axle assembly as set forth in claim 1 wherein said twist beam has a closed cross-section which extends between said opposite ends.

7. The twist axle assembly as set forth in claim 1 wherein said twist beam is generally U-shaped when viewed from above.

8. The twist axle assembly as set forth in claim 1 wherein said end portions of said twist beam are curved from said first direction to said second direction.

9. The twist axle assembly as set forth in claim 1 wherein said middle portion has a pocket formed therein to decrease a torsional stiffness of said middle portion.

10. The twist axle assembly as set forth in claim 1 wherein said middle portion has a first width and each of said end portions have a second width that is greater than said first width.

11. A method of making a twist axle assembly, comprising the steps of:
preparing a single piece twist beam which extends in a first direction between opposite ends; and
bending the twist beam adjacent the ends to present end portions which are disposed on opposite sides of a middle portion and wherein the end portions extend at least partially in a second direction that is generally perpendicular to the first direction.

12. The method as set forth in claim 11 further including the step of welding at least one component to at least one of the end portions of the twist beam.

13. The method as set forth in claim 11 wherein the step of welding the at least one component to at least one of the end portions of the twist beam is further defined as welding wheel carriers to the end portions of the twist beam.

14. The method as set forth in claim 11 wherein the step of bending the end portions of the twist beam is further defined as bending the end portions of the twist beam into an approximately ninety degree curve.

15. The method as set forth in claim 10 further including the step of pressing the middle portion of the twist beam to define a pocket.
